(19) United States
(12) Patent Application Publication
(10) Pub. No.: US 2023/0026287 A1
(43) Pub. Date: Jan. 26, 2023

(54) PET TOY CONTAINER WITH PLAY ELEMENTS

(71) Applicant: PAW U SC LLC, Charleston, SC (US)

(72) Inventor: Sarah Beth Allison, Charleston, SC (US)

(21) Appl. No.: 17/871,796

(22) Filed: Jul. 22, 2022

Related U.S. Application Data
(60) Provisional application No. 63/224,632, filed on Jul. 22, 2021.

(51) Int. Cl. A01K 15/02; B65D 25/10; B65D 25/00; B65D 25/28; B65D 25/22

(52) U.S. Cl. CPC A01K 15/025; B65D 25/10; B65D 25/005; B65D 25/2808; B65D 25/22

(57) ABSTRACT

A pet toy container used during play by a pet and used to store pet toys and accessories. The pet toy container has recessed openings on the outside that receive toys to entice a pet to play with the pet toy container. The pet toy container opens to allow the toys and accessories to be stored in the interior of the pet toy container. The pet toy container includes weights, a grippy bottom surface, and suction cups to hold the apparatus in place during play.

### FIELD OF THE INVENTION

The present invention relates generally to storage containers. More specifically, the present invention relates to containers with play elements for pets.

### BACKGROUND OF THE INVENTION

Owning a pet, such as a dog or cat, can be troublesome as there are a lot of different equipment, accessories, toys, etc. to keep track organized. In addition, there is a high likelihood that the pet will create a messy household by leaving toys, accessories, or of the likes laying around. Having a designated storage unit is important but it can be difficult as pets are able to access the toys and accessories if not handled properly.

An objective of the present invention is to provide a storage unit for toys and accessories. The present invention is a playful structure that can be utilized to enhance and/or assist playful activities for a pet.

### SUMMARY OF THE INVENTION

The present invention is a storage container with play element on the exterior. Recessed openings receive toys or treats to entice a pet to play with the container. A weighted bottom and suction cups on the rear are used to secure the container in place during play. A flap opens to provide access to the interior of the container, where toys, treats, or accessories are stored.

### BRIEF DESCRIPTION OF THE DRAWINGS

FIG. 1 is a perspective view of the present invention.

FIG. 2 is a front view of the present invention.

FIG. 3 is a perspective view of the present invention.

FIG. 4 is a perspective view of an alternate position of the present invention.

FIG. 5 is a perspective view of an alternate position of the present invention.

### DETAILED DESCRIPTION OF THE INVENTION

All illustrations of the drawings are for the purpose of describing selected versions of the present invention and are not intended to limit the scope of the present invention.

The present invention provides a storage container for pet toys and accessories. The present invention is a playful structure that can be utilized to enhance and/or assist playful activities for a pet. The present invention comprises a box structure, a set of front cups, a set of top cups, a set of suction cups, a base, and an interior panel.

Embodiment 1 of the present invention is a storage container with a substantially box shape with an openable front flap. The top panel and front flap of the container have recessed cups. Toys or treats can be inserted into the cups to entice a pet, such as a dog or cat, to play with the storage container to retrieve the toys or treats. When the pet is done playing, the toys or treats can be stored inside the storage container.

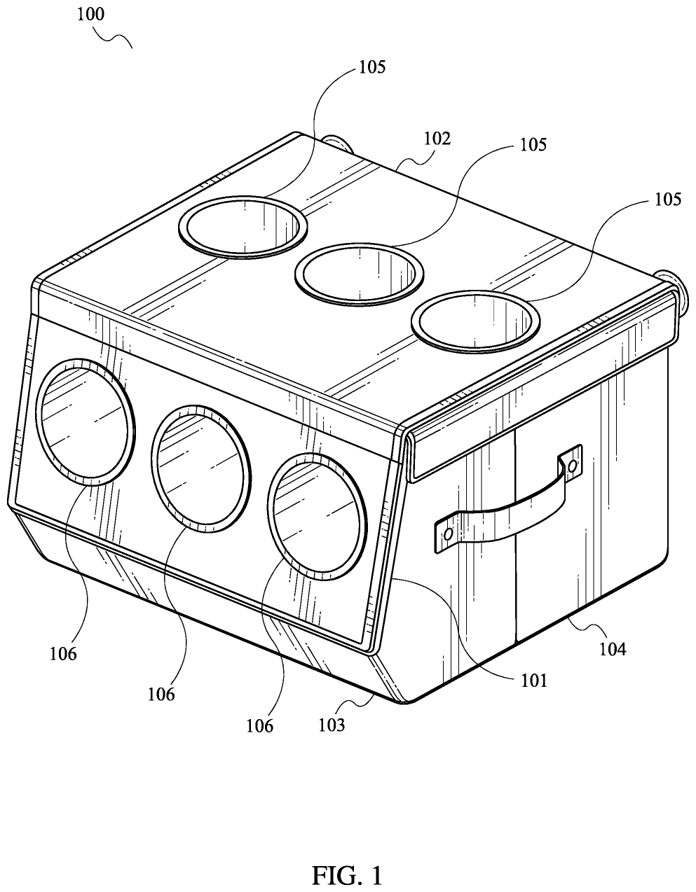

Referring to FIG. 1, Embodiment 1 of the present invention comprises container 100. Container 100 has an overall box shape with a peculiar front surface. Container 100 comprises front flap 101, top panel 102, front panel 103, and right panel 104. The top panel includes top cups 105. Front flap 101 includes front cups 106. Front flap 101 opens to provide access to the interior of container 100. The panels and flap comprise a semi-rigid sheet layered between fabric, giving the panels structural support while maintaining flexibility. For example, cardboard is covered with canvas. Each panel and flap contains a separate semi-rigid sheet. A continuous piece of fabric covers adjacent panels, binding the panels together with a flexible joint. Front flap 101 is connected to top panel 102. Top panel 102 is connected to right panel 104. Right panel is connected to front panel 103. Top cups 105 are pressed into openings in the top surface of container 100. Front cups 106 are pressed into openings in front flap 101. In Embodiment 1, top cups 105 and front cups 106 comprise a rigid material. For example, the cups may be made of hard plastic. In alternate embodiments, the cups may be made of a flexible material, such as cloth. In Embodiment 1, three top cups 105 and three front cups 106 are used. In alternate embodiments, any number of top cups and any number of front cups may be used. Top cups 105 and front cups 106 provide a recessed volume to insert toys or treats to encourage the pet to play. For example, toys may be inserted into front cups 106 to entice the pet to retrieve the toy.

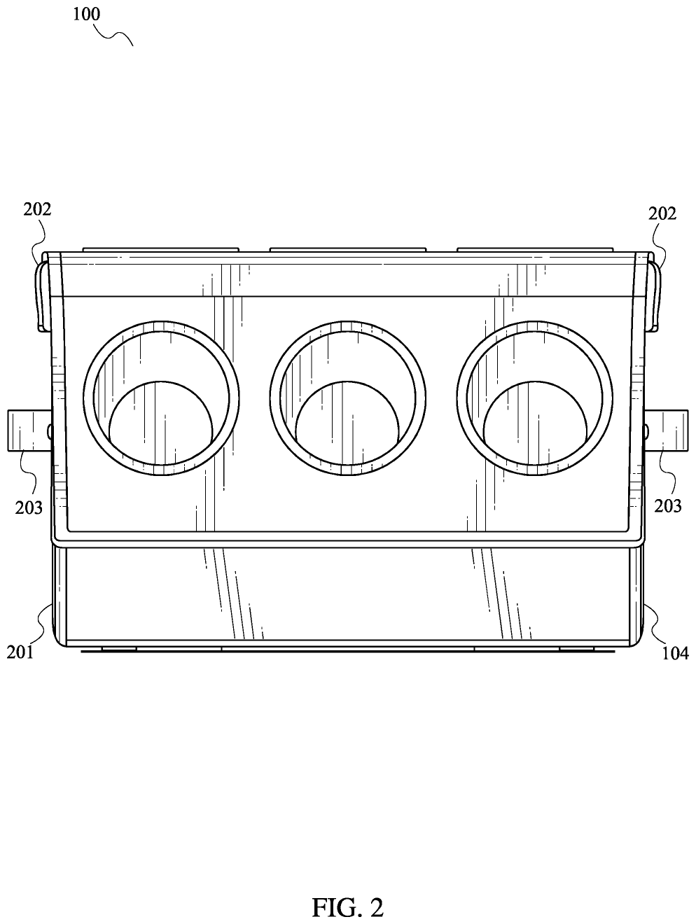

Referring to FIG. 2, Embodiment 1 of the present invention comprises container 100. Left panel 201 is a mirror image of right panel 104. Left panel 201 is attached to top panel 102 and front panel 103. The panels comprise a semi-rigid sheet layered between fabric, giving the panels structural support while maintaining flexibility. For example, cardboard is covered with canvas. Each panel contains a separate semi-rigid sheet. A continuous piece of fabric covers adjacent panels, binding the panels together with a flexible joint. One handle 203 is attached to left panel 201, and one handle 203 is attached to right panel 104. In Embodiment 1, two handles 203 are attached to container 100. In alternate embodiments, a single handle or more than two handles may be attached. Handles 203 are used to hold container 100 when lifting, carrying, or maneuvering. Support flaps 202 join each end of top panel 102 to the adjacent side panels. One support flap 202 is connected to top panel 102 and to right panel 104, and one support flap 202 is connected to top panel 102 and to left panel 201. In Embodiment 1, support flaps 202 attach to the side panels with hook and loop material. In alternate embodiments, other types of non-permanent or permanent attachments may be used. Support flaps provide additional structural support to container 100.

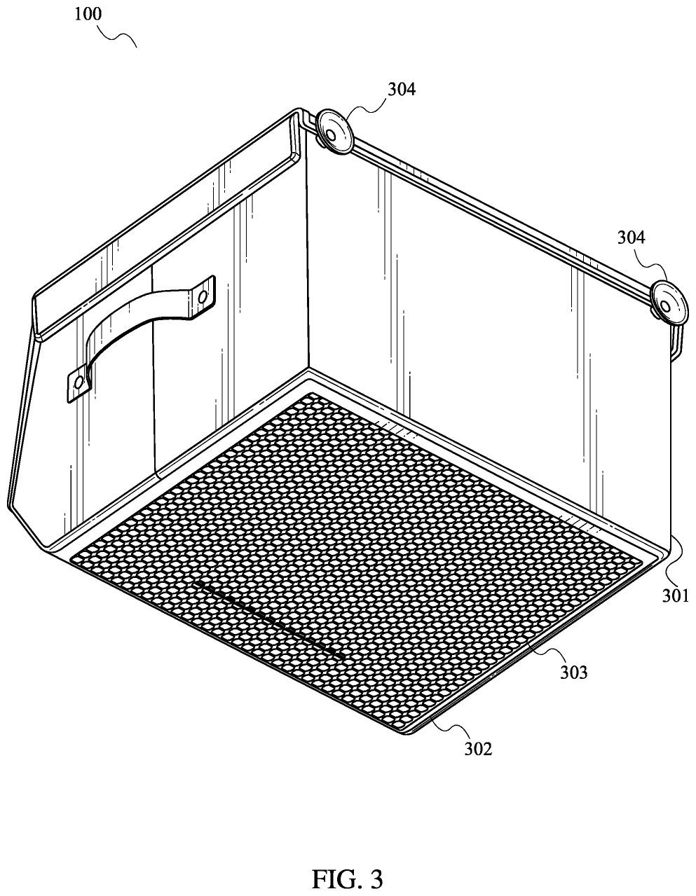

Referring to FIG. 3, Embodiment 1 of the present invention comprises container 100. Back panel 301 connects to bottom panel 302, top panel 102, right panel 104, and left panel 201. Bottom panel 302 connects to front panel 103, right panel 104, left panel 201, and back panel 301. The panels comprise a semi-rigid sheet layered between fabric, giving the panels structural support while maintaining flexibility. For example, cardboard is covered with canvas. Each panel contains a separate semi-rigid sheet. A continuous piece of fabric covers adjacent panels, binding the panels together with a flexible joint. Bottom panel 302 of container 100 is covered by grippy surface 303. For example, bottom panel 302 may be covered in a rubberized netting material. Grippy surface 303 increases the frictional resistance to horizontal movement of container 100, preventing container 100 from accidentally sliding from the intended placement. Suction cups 304 are attached to back panel 201 of container 100. In Embodiment 1, one suction cup 304 is attached to back panel 301 adjacent to top panel 102 and right panel 104. A second suction cup 304 is attached to back panel 301 adjacent to top panel 102 and left panel 201. In alternate embodiments, one or more than two suction cups may be used. Suction cups 304 allow container 100 adhere to smooth surfaces, increasing resistance to movement. Grippy surface 303 and suction cups 304 are used in combination prevent movement of container 100.

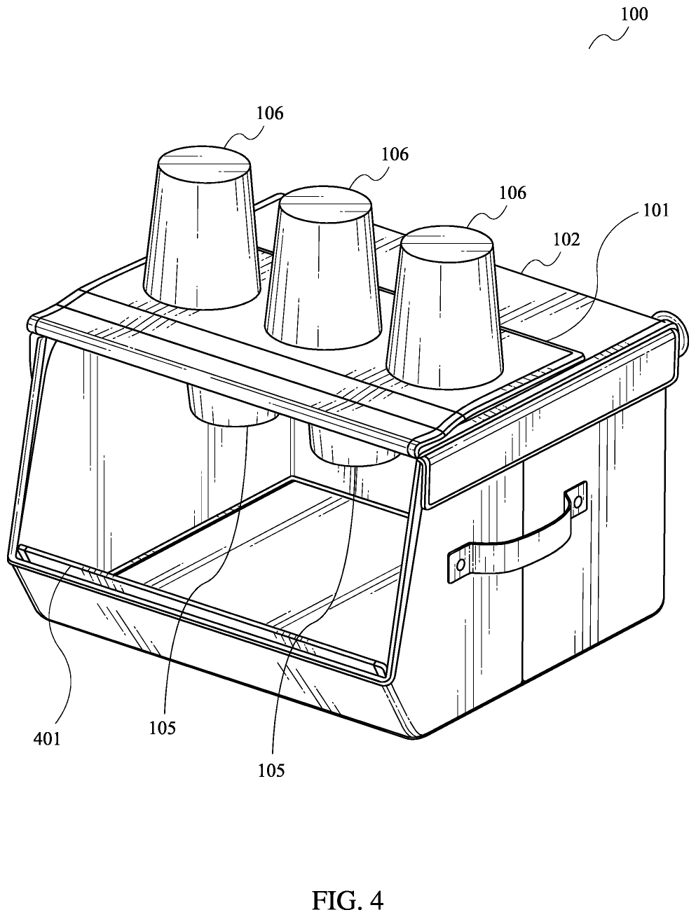

Referring to FIG. 4, Embodiment 1 of the present invention comprises container 100. Front flap 101 is opened to provide access to the interior of container 100. Front cups 106 are inverted when flap 101 is rotated above top panel 102. Top cups 105 hang from top panel 102 into the internal volume of container 100. Toys or accessories can be stored inside container 100 when they are not in use. Bottom tray 401 is placed on the bottom surface of the interior of container 100. Bottom tray 401 comprising a semi-rigid material layered with a fabric. For example, bottom tray 401 comprises cardboard layered between canvass. Bottom tray 401 provides additional structural support to container 100. In Embodiment 1, bottom tray 401 includes a metal or plastic frame that adds rigidity to the bottom of container 100.

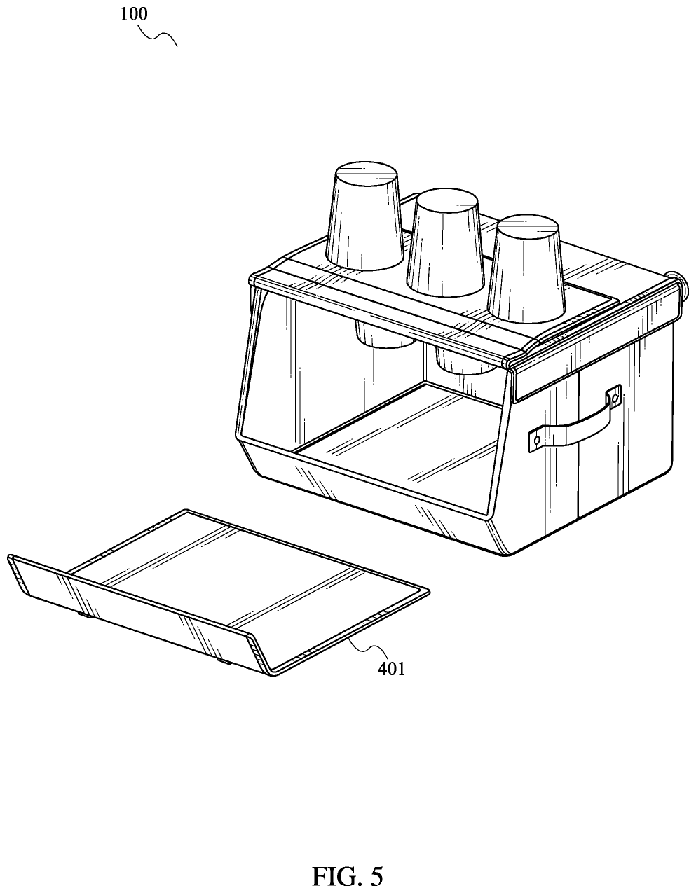

Referring to FIG. 5, Embodiment 1 comprises container 100. Bottom tray 401 is removed from the interior of container 100, giving access to the interior surface of the bottom panel of container 100.

To prepare Embodiment 1 of the present invention for use, front flap 101 is opened, and bottom tray 401 is removed. Weighted material, such as sand or gravel, is placed in the bottom of the interior of container 100. Bottom tray 401 is replaced in the bottom of the interior of container 100, concealing the weighted material. In Embodiment 2, bottom tray 401 includes fillable pouches. The pouches are filled with weighted material, such as sand or gravel, then sealed with hook and loop material. Bottom tray 401 is placed back in the interior of container 100.

To use Embodiment 1 of the present invention as a storage container, front flap 101 is opened to store toys, treats, accessories, or similar items. Once the items have been placed within the interior of the storage container, front flap 101 is closed to secure the contents within the storage container.

To use Embodiment 1 of the present invention as a playful structure, front flap 101 is opened to remove toys or treats from the interior of container 100. Front flap 101 is closed, and the toys or treats are inserted into top cups 105 and/or front cups 106. The pet then attempts to remove the toys or treats from the cups.

Although the invention has been explained in relation to its preferred embodiment, it is to be understood that many other possible modifications and variations can be made without departing from the spirit and scope of the invention as hereinafter claimed.

What is claimed is:

1. A container, comprising:
a top panel;
a front flap connected to the top panel;
a back panel connected to the top panel;
a bottom panel connected to the back panel;
a first side panel connected to the top panel and connected to the back panel and connected to the bottom panel;
a second side panel connected to the top panel and connected to the back panel and connected to the bottom panel;
a front panel connected to the bottom panel and connected to the first side panel and connected to the second side panel; and
a first set of cups recessed in the top panel.

2. The container of claim 1, further comprising a second set of cups recessed in the front flap.

3. The container of claim 1, further comprising:
a first support flap connected to the top panel and connected to the first side panel; and
a second support flap connected to the top panel and connected to the second side panel.

4. The container of claim 3, further comprising:
a first set of hook and loop surfaces connecting the first support flap to the first side panel; and
a second set of hook and loop surfaces connecting the second support flap to the second side panel.

5. The container of claim 1, further comprising a removable tray.

6. The container of claim 1, further comprising a set of handles.

7. The container of claim 6, wherein the set of handles further comprises:
a first handle connected to the first side panel; and
a second handle connected to the second side panel.

8. The container of claim 1, further comprising a set of suctions cups connected to the back panel.

9. The container of claim 8, wherein the set of suction cups further comprises:
a first suction cup connected to the back panel, the first suction cup connected adjacent to the top panel and adjacent to the first side panel; and
a second suctions cup connected to the back panel, the second suction cup connected adjacent to the top panel and adjacent to the first side panel.

10. A container comprising:
a top panel;
a front flap connected to the top panel;
a back panel connected to the top panel;
a bottom panel connected to the back panel;
a first side panel connected to the top panel and connected to the back panel and connected to the bottom panel;
a second side panel connected to the top panel and connected to the back panel and connected to the bottom panel;
a front panel connected to the bottom panel and connected to the first side panel and connected to the second side panel;
a first set of cups recessed in the top panel;
a second set of cups recessed in the front flap.

11. The container of claim 10, further comprising a removable tray.

12. The container of claim 10, further comprising:
a first support flap connected to the top panel and connected to the first side panel; and
a second support flap connected to the top panel and connected to the second side panel.

13. The container of claim 12, further comprising:
a first set of hook and loop surfaces connecting the first support flap to the first side panel; and
a second set of hook and loop surfaces connecting the second support flap to the second side panel.

14. The container of claim 12, further comprising:
a first handle connected to the first side panel; and
a second handle connected to the second side panel.

15. The container of claim 12, further comprising:
a first suction cup connected to the back panel, the first suction cup connected adjacent to the top panel and adjacent to the first side panel; and
a second suction cup connected to the back panel, the second suction cup connected adjacent to the top panel and adjacent to the second side panel.

16. A container comprising:
a top panel;
a front flap connected to the top panel;
a back panel connected to the top panel;
a bottom panel connected to the back panel, the bottom panel comprising a gripping surface;
a first side panel connected to the back panel and connected to the bottom panel;
a second side panel connected to the back panel and connected to the bottom panel;
a front panel connected to the bottom panel and connected to the first side panel and connected to the second side panel;
a first support flap connected to a first side edge of the top panel and connected to a top edge of the first side panel;
a second support flap connected to a second side edge of the top panel and connected to a top edge of the second side panel;
a first set of cups recessed in the top panel; and
a second set of cups recessed in the front flap.

17. The container of claim 16, further comprising:
a first set of hook and loop surfaces connected to the first support flap and connected to the first side panel; and
a second set of hook and loop surfaces connected to the second support flap and connected to the second side panel.

18. The container of claim 16, further comprising a removable tray.

19. The container of claim 16, further comprising:
a first handle connected to the first side panel; and
a second handle connected to the second side panel.

20. The container of claim 16, further comprising:
a first suction cup connected to the back panel, the first suction cup connected adjacent to the top panel and adjacent to the first side panel; and
a second suction cup connected to the back panel, the second suction cup connected adjacent to the top panel and adjacent to the second side panel.
